(19) United States
(12) Patent Application Publication
(10) Pub. No.: US 2017/0277168 A1
(43) Pub. Date: Sep. 28, 2017

(54) ADDITIVE MANUFACTURING APPARATUS AND COMPUTER PROGRAM PRODUCT

(71) Applicant: Kabushiki Kaisha Toshiba, Minato-ku (JP)

(72) Inventors: Masayuki TANAKA, Yokohama (JP); Takahiro Terada, Yokohama (JP); Ryuichi Teramoto, Yokohama (JP)

(73) Assignee: Kabushiki Kaisha Toshiba, Minato-ku (JP)

(21) Appl. No.: 15/446,150

(22) Filed: Mar. 1, 2017

(30) Foreign Application Priority Data
Mar. 24, 2016 (JP) 2016-059601

(51) Int. Cl. G05B 19/4099; B29C 67/00

(52) U.S. Cl. CPC G05B 19/4099; B29C 67/0088; B33Y 50/02

(57) ABSTRACT

An additive manufacturing apparatus according to an embodiment includes an acquirer, a generator, and an additive manufacturing unit. The acquirer acquires, from three-dimensional shape data, shape data of each layer in a predetermined thickness to be added for manufacturing an object. The generator generates, from the shape data of each layer, layer modeling data representing a cross-sectional shape of modeling data having a lattice structure converted from the inside of the object generated from the three-dimensional shape data. The additive manufacturing unit forms each layer in the predetermined thickness and adds the layers for manufacturing the object, in accordance with the layer modeling data generated by the generator.

### CROSS-REFERENCE TO RELATED APPLICATIONS

This application is based upon and claims the benefit of priority from Japanese Patent Application No. 2016-059601, filed Mar. 24, 2016, the entire contents of which are incorporated herein by reference.

### FIELD

Embodiments described herein relate generally to an additive manufacturing apparatus and a computer program product.

### BACKGROUND

Conventionally, an additive manufacturing apparatus such as a 3D printer has been proposed, which manufactures a three-dimensional object by solidifying each layer of a powder material with binder (binding agent) or laser beam and adding layer upon layer of the material.

For creating a three-dimensional (3D) shape, a technique for employing a three-dimensional internal lattice structure is proposed. This however may increase a data amount of a 3D shape model to form the 3D shape, increasing a processing load.

An embodiment of the present invention aims to provide an additive manufacturing apparatus and a computer program product which can easily manufacture 3D shapes regardless of data amounts of 3D shape models.

### BRIEF DESCRIPTION OF THE DRAWINGS

FIG. 1 is a diagram exemplifying an information processor and a configuration of a 3D additive manufacturing apparatus according to a first embodiment;

FIG. 2 is a diagram exemplifying a process in which an object is manufactured from surface shape data;

FIG. 3 is a diagram illustrating exemplary modeling data representing an object to be manufactured;

FIG. 4 is a diagram illustrating exemplary modeling data of a layer in the first embodiment;

FIG. 5 is a flowchart of the processing by the 3D additive manufacturing apparatus in the first embodiment;

FIG. 6 is a diagram illustrating a process in which an arbitrary face of an object is formed in an arbitrary thickness by a 3D additive manufacturing apparatus according to a modification of the first embodiment;

FIG. 7 is a diagram exemplifying an information processor and a configuration of a 3D additive manufacturing apparatus according to a second embodiment;

FIG. 8 is an explanatory diagram illustrating a region requiring a support material;

FIG. 9 is a diagram illustrating an example of generating modeling data based on a target layer of surface shape data;

FIG. 10 is a diagram illustrating a region, of the target layer illustrated in FIG. 9, requiring the support material;

FIG. 11 is a diagram illustrating an example of generating modeling data based on a target layer of surface shape data;

FIG. 12 is a diagram illustrating a region, of the target layer illustrated in FIG. 11, requiring the support material;

FIG. 13 is a flowchart of a determining processing by a determiner of the 3D additive manufacturing apparatus in the second embodiment;

FIG. 14 is a diagram exemplifying an information processor and a configuration of a 3D additive manufacturing apparatus according to a third embodiment;

FIG. 15 is a diagram exemplifying a change in the density of lattice cells constituting an object to be manufactured according to the third embodiment;

FIG. 16 is a diagram exemplifying a difference between a unit cell of voxel data and a size of lattice cell shape data; and

FIG. 17 is a diagram illustrating an exemplary data conversion by a converter in the third embodiment.

### DETAILED DESCRIPTION

In general, according to one embodiment, an additive manufacturing apparatus includes an acquirer, a generator, and an additive manufacturing unit. The acquirer acquires, from three-dimensional shape data, shape data of each layer in a predetermined thickness to be added for manufacturing an object. The generator generates, from the shape data of each layer, layer modeling data representing a cross-sectional shape of modeling data having a lattice structure converted from the inside of the object generated from the three-dimensional shape data. The additive manufacturing unit forms each layer in the predetermined thickness and adds the layers for manufacturing the object, in accordance with the layer modeling data generated by the generator.

The following will describe embodiments of an additive manufacturing apparatus and a program in detail with reference to the accompanying drawings.

### First Embodiment

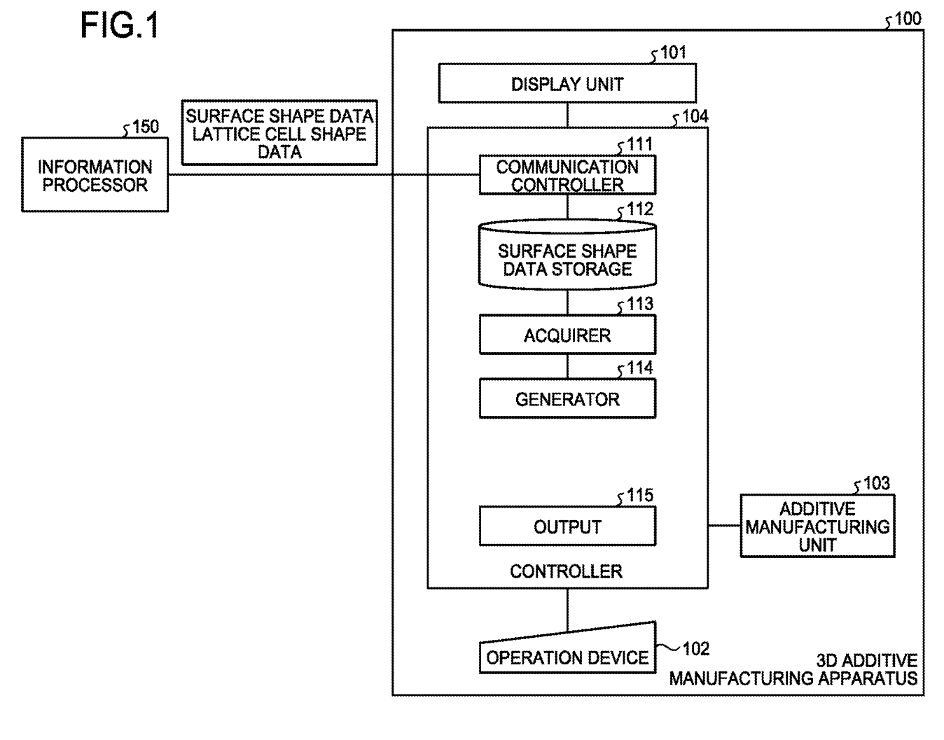

FIG. 1 exemplifies an information processor and a configuration of a three-dimensional (3D) additive manufacturing apparatus according to a first embodiment.

An information processor 150 transmits surface shape data and lattice cell shape data to a 3D additive manufacturing apparatus 100.

The surface shape data is exemplary 3D shape data used by the 3D additive manufacturing apparatus 100 for manufacturing an object and represents a three-dimensional shape of a free-form surface of a material. The present embodiment will describe an example of transmitting surface shape data as the data representing the 3D shape. However, the data should not be limited to the surface shape data, and may be any data such as a solid model as long as the 3D additive manufacturing apparatus 100 can recognize the data as a 3D shape.

The lattice cell shape data represents stereoscopic shape data of lattice cells of a lattice structure that corresponds to an internal structure of an object to be manufactured in accordance with the surface shape data.

The information processor 150 of the present embodiment transmits the surface shape data created by, for example, a 3D CAD application together with the lattice cell shape data by way of example, however, it should not be limited to such an example. A different information processor may also transmit the lattice cell shape data, or the 3D additive manufacturing apparatus 100 may also pre-store the lattice cell data.

The 3D additive manufacturing apparatus 100 includes a display unit 101, an operation device 102, an additive manufacturing unit 103, and a controller 104.

The operation device 102 is a device that receives operation to the 3D additive manufacturing apparatus 100.

The display unit 101 displays information on an object under additive manufacturing by the 3D additive manufacturing apparatus 100.

The additive manufacturing unit 103 manufactures an object of a predetermined shape by, for example, supplying a material to a target object with a nozzle to form a layer and adding layer-upon-layer of the material in accordance with a command from the controller 104. The material to be laminated is, for example, predetermined powder. The material to be laminated is not limited to one kind of material and may also be two or more kinds.

The additive manufacturing unit 103 of the present embodiment adds layer-upon-layer of the material in accordance with the modeling data of each layer transmitted from the controller 104. A manufactured object in the present embodiment has a three-dimensional structure including fine lattices arranged in a predetermined pattern.

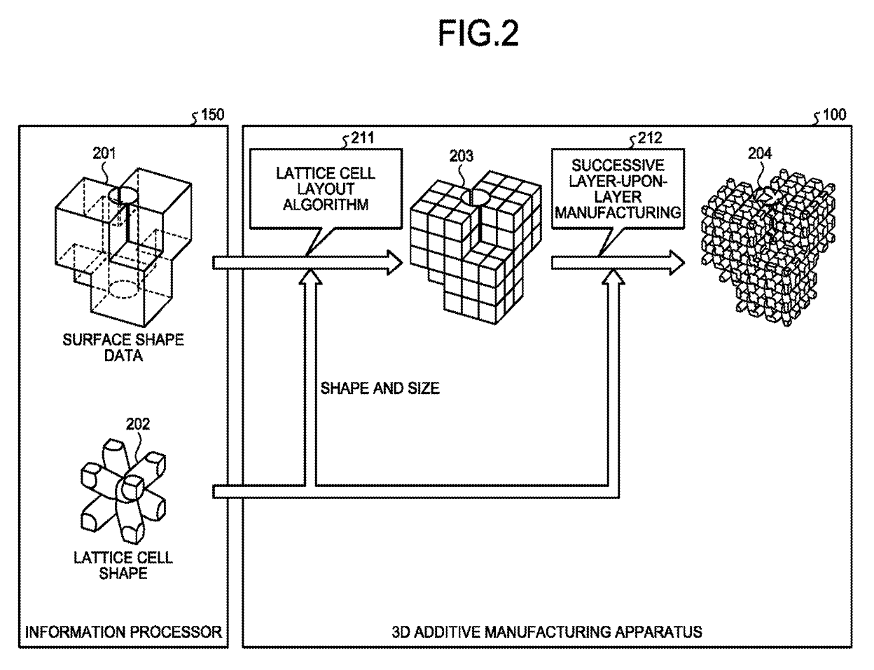

FIG. 2 exemplifies a process of manufacturing an object from surface shape data. As illustrated in FIG. 2, the information processor 150 transmits surface shape data 201 and lattice cell shape data 202 to the 3D additive manufacturing apparatus 100.

A lattice cell layout 203 represents the surface shape data segmented into lattice cell shapes depending on a size in order to arrange lattice cells in a void of the surface shape data. The lattice cell layout 203 can be specified by execution of a lattice cell layout algorithm 211.

In the present embodiment, the lattice cell layout 203 is derived by the lattice cell layout algorithm 211 every time a layer is formed for additive manufacturing of an object 204.

The additive manufacturing unit 103 allocates the lattice cells indicated by the lattice cell shape data 202 to the object 204 in accordance with the sizes segmented in the lattice layout 203, and forms each layer and adds a layer upon a layer to manufacture the object 204 (successive adding 212).

Thus, the additive manufacturing unit 103 of the present embodiment additively manufactures an object in accordance with the layer modeling data output from the controller 104.

The modeling data is defined to be data to control a jetting of a material of an object to be additively manufactured by the additive manufacturing unit 103. The modeling data of the present embodiment is defined to be data to generate an object having a lattice structure by dividing the 3D shape indicated by the surface shape data into unit regions of a stereoscopic lattice form and size (e.g., cube having each side of 0.1 mm) and replacing each of the divided unit regions by a stereoscopic lattice cell.

The modeling data representing the 3D shape of the object 204 has a complex shape of fine lattices and is thus enormous in terms of data size. For example, in case of arranging lattices with a width of 0.1 mm in a 10-mm square region, the data size thereof will be 100 GB. The use of modeling data with such a large data size will increase a processing load for additive manufacturing.

In view of this, the controller 104 of the present embodiment generates the modeling data in unit of layer for output to the additive manufacturing unit 103. The additive manufacturing unit 103 additively manufactures the object layer by layer. This can decrease the size of data to be processed by the controller 104 and to be received by the additive manufacturing unit 103, resulting in reducing the processing load.

Thus, while FIG. 2 shows the example of the overall shape of the lattice cell layout 203 for the sake of explanation, the controller 104 acquires shape data of each layer from the surface shape data and converts it into a lattice cell layout in the present embodiment. This can reduce the size of data to be processed.

In the present embodiment, the 3D shape indicated by the surface shape data is converted to the lattice cell layout in accordance with a predetermined pattern. Hence, which part of the lattice cell is to be converted can be derived for each region of the shape data per layer by the lattice cell layout algorithm 211. This makes it possible to manufacture an object with no inconsistency among layers even in case of converting the surface shape data to the modeling data with the lattice structure in unit of layer.

The controller 104 implements a communication controller 111, an acquirer 113, a generator 114, and an output 115 by a CPU's executing a program stored in a ROM. A surface shape data storage 112 is provided in a RAM.

The communication controller 111 transmits and receives information to/from an external apparatus. For example, the communication controller 111 receives the surface shape data and the lattice cell shape data from the information processor 150.

The surface shape data storage 112 stores the received surface shape data and lattice cell shape data. The present embodiment describes the example of receiving the lattice cell shape data. However, the lattice cell shape data may also be pre-stored in the surface shape data storage 112. In this case, the 3D additive manufacturing apparatus 100 receives only the surface shape data from the information processor 150.

The acquirer 113 acquires, from the surface shape data stored in the surface shape data storage 112, divided surface shape data of each layer of a predetermined thickness to be added for manufacturing the object by the additive manufacturing unit 103. The predetermined layer thickness may be set, but should not be limited, to a thickness of one layer to be formed by the additive manufacturing unit. The layer thickness may be arbitrarily set as long as it enables reduction in the processing load.

The generator 114 generates, from the shape data of each layer, layer modeling data representing a cross sectional shape of the modeling data of the lattice structure, converted from the inside of the object modeled from the surface shape data.

The generator 114 of the present embodiment generates the layer modeling data. The layer modeling data is a part of the modeling data with the lattice structure. The modeling data with the lattice structure is generated by dividing the surface shape data into 3D regions having a preset stereoscopic lattice shape and size, and replacing each divided 3d regions with the lattice cell shape data stored in the surface shape data storage 112.

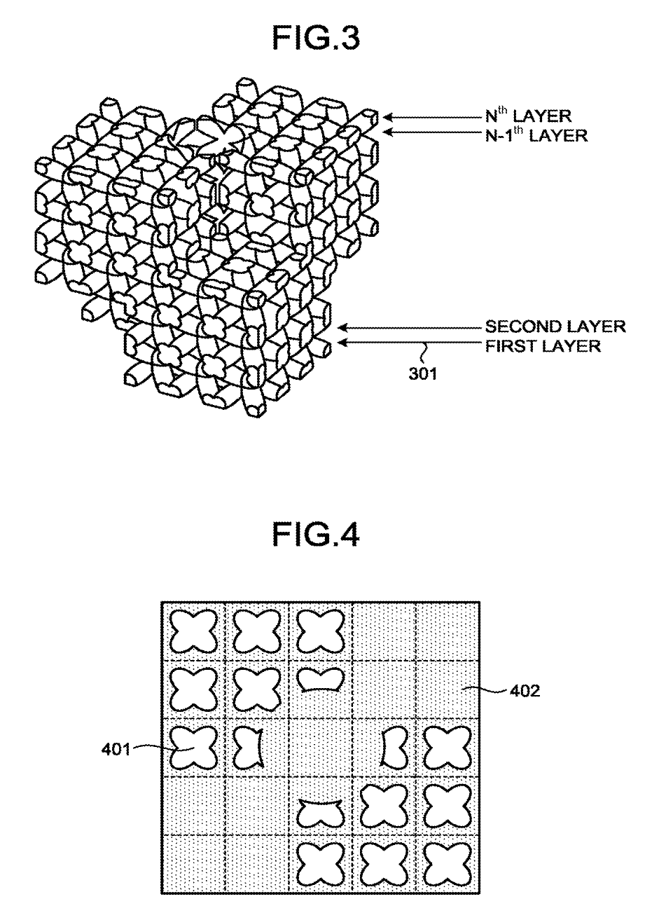

FIG. 3 illustrates exemplary modeling data representing an object to be generated. The object illustrated in FIG. 3 is additively manufactured from the surface shape data and the lattice cell shape data. The object is manufactured by adding layer upon layer in the order of a first layer, a second layer, . . . , an N−1^{th} layer, and an N^{th} layer.

As illustrated in FIG. 3, a cross-sectional shape of each layer of the object can be specified from the arrangement of the stereoscopic lattices, the stereoscopic lattice shape, and a height of the layer. In other words, the lattice cell layout algorithm 211 is preset to include a step of dividing the surface shape data into unit regions having the stereoscopic lattice shape and size (e.g., cube having each side of 0.1 mm) and a step of converting the unit regions into the stereoscopic lattices. Thereby, upon input of a height of a layer, the steps of dividing the surface shape data into the unit regions and converting the unit regions into the stereoscopic lattices are invoked from the lattice layout algorithm 211, to thereby specify the cross-sectional shape of the modeling data on the layer.

In other words, the generator 114 can specify (a height of) a next layer to be added to generate modeling data of the layer in question by the lattice cell layout algorithm 211.

FIG. 4 illustrates an example of layer modeling data in the present embodiment. FIG. 4 illustrates an exemplary arrangement of a material 401 and a support material 402 forming a first layer 301 of the object in FIG. 3. In the present embodiment, since the modeling data is generated for each layer, a shape of the object above the layer in question is not concerned. Thus, the additive manufacturing unit 103 of the present embodiment needs to arrange the support material 402 in a region other than the regions in which the material 401 of the object is arranged.

The output 115 outputs, to the additive manufacturing unit 103, the modeling data for each layer generated by the generator 114.

For forming and adding layers in the predetermined thickness, the additive manufacturing unit 103 receives the layer modeling data and arranges a material of the object in accordance with the modeling data. The additive manufacturing unit 103 arranges the support material in the region except for the regions in which the material is arranged. Thereby, the additive manufacturing unit 103 in the present embodiment can manufacture an object without the need for recognizing the overall shape of the object.

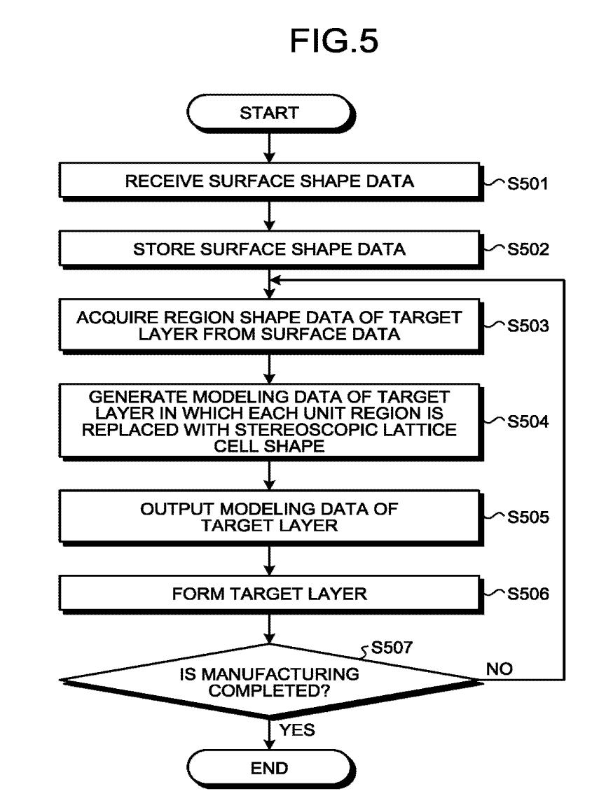

Next, the overall processing by the 3D additive manufacturing apparatus 100 of the present embodiment will be described. FIG. 5 is a flowchart of the processing by the 3D additive manufacturing apparatus 100 of the present embodiment.

First, the communication controller 111 receives surface shape data from the information processor 150 (S501). Also, the communication controller 111 receives lattice cell shape data from the information processor 150. The communication controller 111 may receive the lattice cell shape data together with the surface shape data or separately.

The communication controller 111 stores the received surface shape data and lattice cell shape data in the surface shape data storage 112 (S502).

The acquirer 113 acquires shape data of a region (where a material is arranged) of a layer to be added by the additive manufacturing unit 103, from the surface shape data stored in the surface shape data storage 112 (S503). The acquirer 113 of the present embodiment acquires the shape data of the regions in the order of layers to be added, starting from a lowermost layer of the surface shape data.

The generator 114 generates modeling data of a target layer (to be added) based on the acquired shape data of the regions of the layer. The modeling data of the target layer represents a cross-sectional shape of the modeling data in which each unit region is replaced with a stereoscopic lattice cell shape (S504).

The output 115 outputs, to the additive manufacturing unit 103, the modeling data of the target layer generated by the generator 114 (S505).

Then, the additive manufacturing unit 103 forms and adds each target layer based on the modeling data (S506).

The controller 104 determines whether additive manufacturing of the object based on the surface shape data is completed (S507). Upon determining no completion of the additive manufacturing (No in S507), the control unit 104 starts the processing from S503 again.

Meanwhile, upon determining completion of the additive manufacturing of the object based on the surface shape data (Yes in S507), the controller 104 ends the processing.

In the present embodiment, the modeling data is generated for each layer of the object of the additive manufacturing in accordance with the modeling data of each layer. Thereby, owing to the internal lattice structure of the object, processing based on the modeling data of each layer can reduce the size of data used, although the size of the modeling data of the entire object is large. This can reduce a processing load.

Modification of First Embodiment

The first embodiment has not considered the shape of a face for converting the entire internal structure of the surface shape data to the lattice structure. In view of this, the modification of the first embodiment will describe an example of forming an arbitrary face of an object in an arbitrary thickness.

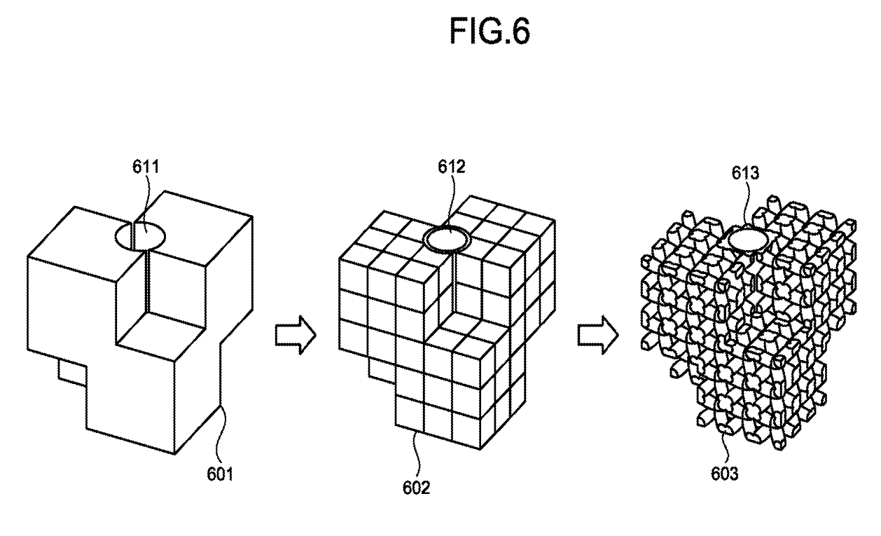

FIG. 6 illustrates the process in which a 3D additive manufacturing apparatus 100 according to the modification of the first embodiment forms an arbitrary face of an object in an arbitrary thickness. In the example illustrated in FIG. 6, the display unit 101 displays surface shape data 601 stored in the surface shape data storage 112.

The controller 104 receives, from the operation device 102, an operation for setting the thickness of a face 611 of the surface shape data 601. Also, the controller 104 may receive this thickness setting operation at the time of receiving thickness setting operation relative to a face.

Then, the generator 114 excludes the face 612 having the thickness set from a target to be divided into the lattice cells of a shape and size, when generating a lattice cell layout 602 from the surface shape data 601.

Thereby, the face 612 with the thickness set is not converted into a stereoscopic lattice shape, and is formed as a region having a thickness.

Thus, the generator 114 of the modification achieves setting an arbitrary face of the modeling data in an arbitrary thickness at the time of generating the layer modeling data.

For manufacturing the object 603, the additive manufacturing unit 103 forms a region 613 having a thickness and not converted into the stereoscopic lattice shape as the face having the arbitrary thickness.

The present modification enables a desired face to be formed in a desired thickness when generating an object having the internal lattice structure, allowing users to create an object as they desire.

### Second Embodiment

The first embodiment has described the example in which the region where the material of the object is not jetted (arranged) is filled with the support material at the time of forming each layer. However, an enormous amount of the support material will be necessary for filling all the regions to which the material is not jetted. A second embodiment will describe an example in which use of the support material is inhibited in accordance with the shape of an object to be manufactured.

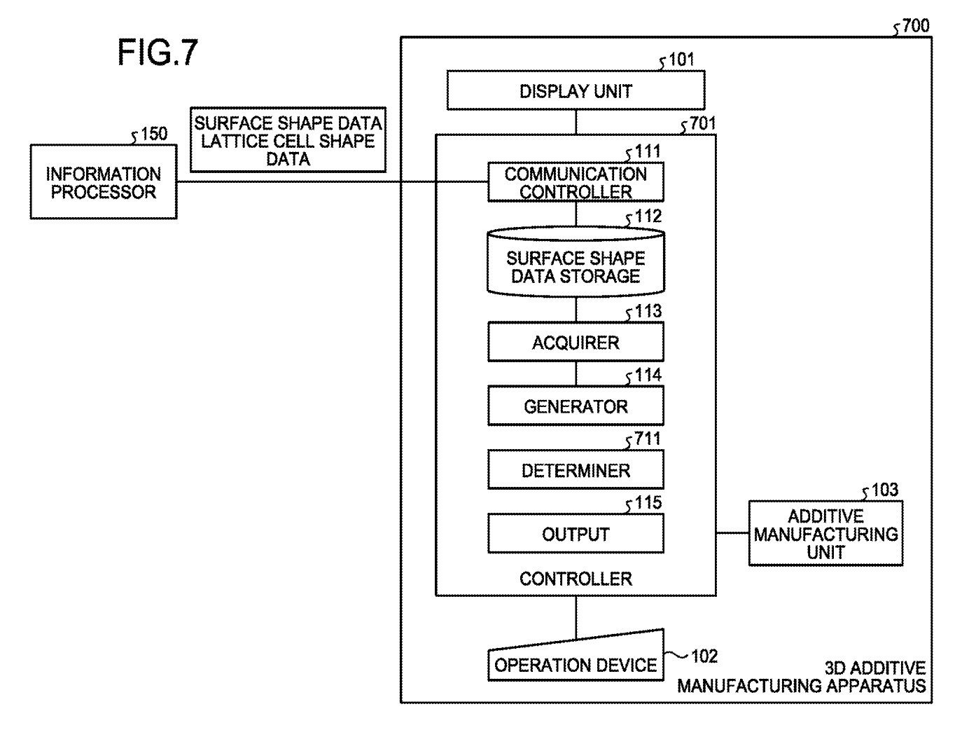

FIG. 7 exemplifies an information processor and a configuration of a 3D additive manufacturing apparatus according to the second embodiment. A 3D additive manufacturing apparatus 700 of the second embodiment includes, for example, a controller 701 that differs in processing from the 3D additive manufacturing apparatus 100 of the first embodiment.

The controller 701 additionally includes a determiner 711, compared to a controller 104 of the first embodiment.

At the time of additive manufacturing from layer modeling data, the determiner 711 determines, in unit of region in a layer, whether the region requires a support material, in accordance with a shape of surface shape data. The determiner 711 of the present embodiment determines whether the region requires the support material, based on the surface shape data stored in a surface shape data storage 112.

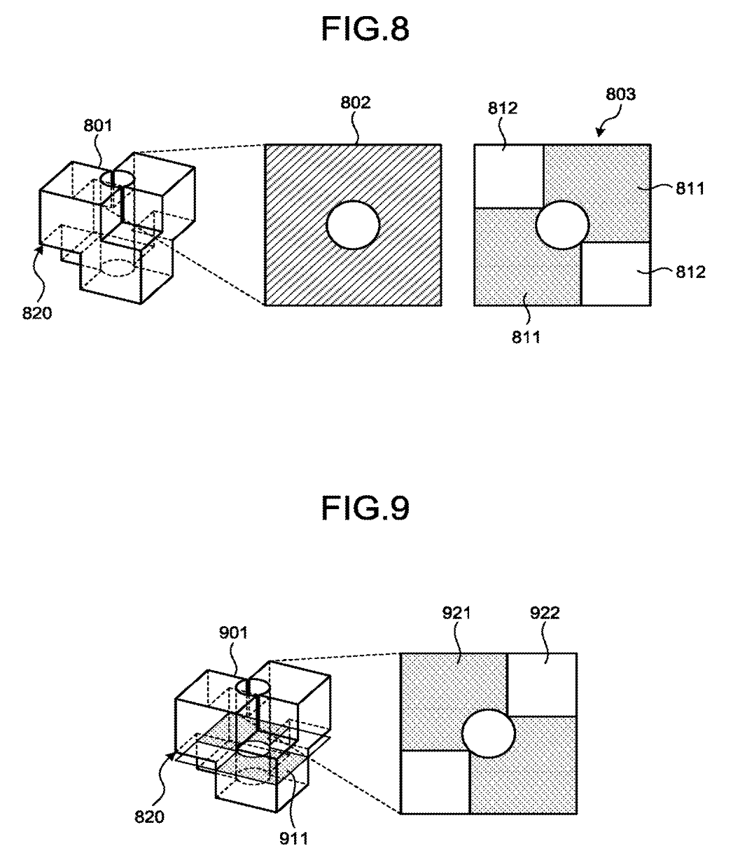

FIG. 8 illustrates a support-material requiring region, for example. As seen from the top, surface shape data 801 illustrated in FIG. 8 contains a region 802 which requires the support material. Meanwhile, the determiner 711 determines that the support material is not required for a cylindrical hollow region at the center of the surface shape data 801, since stereoscopic lattices are not formed in this region.

In additive manufacturing from the bottom face, the surface shape data 801 changes in shape at a height 820. In other words, in a case where the object includes another part above the height 820 and the part below the height 820 is a subject of additive manufacturing, the arrangement of the support material is required even for the region including no part of the object in order to support the part thereabove (hereinafter, the region including no part of the object may be referred to as an external region).

On the other hand, for additive manufacturing of the part above the height 820, no support material is required for the region including no part of the object (external region) (because no part of the object exists above the height).

In the present embodiment, maximal height information is defined to represent the maximal height of the region that requires the arrangement of the support material.

A region 803, which requires the arrangement of the support material as indicated by the maximal height information, contains regions 812 requiring the support material up to the height 820 and regions 811 requiring the support material up to the maximal height of the object. When the generator 114 generates the layer modeling data, the determiner 711 determines whether the support material is required for the layer in question in accordance with height information on the layer.

FIG. 9 illustrates an example of generating modeling data based on a target layer 911 of surface shape data 901. The target layer 911 illustrated in FIG. 9 is below the height 820.

The target layer 911 is formed of an inner region 921 (including part of the object) and external regions 922 (including no part of object).

The determiner 711 then determines whether the external regions 922 is included in the region 802 requiring the support material in FIG. 8. When determining that the external regions 922 is included in the support-material requiring region 802, the determiner 711 determines whether the external regions 922 require the support material, based on the region 803 at the maximal height as indicated by maximal height information. Thus, the determiner 711 determines the necessity of the support material when the height of a current layer is lower than the maximal height of the regions 811 corresponding to the external regions 922.

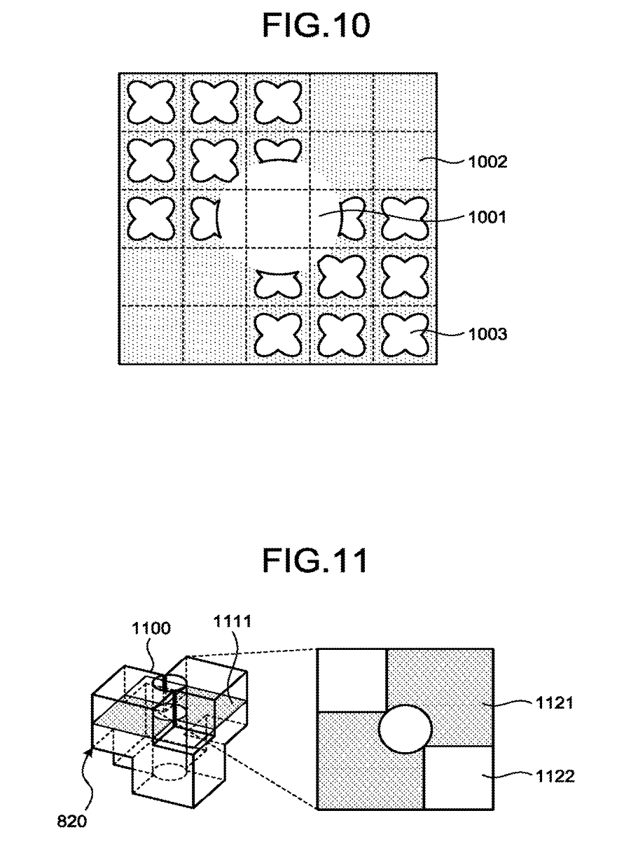

FIG. 10 illustrates the support-material requiring region in the target layer 911 illustrated in FIG. 9. In the example of FIG. 10, a circular region 1001 does not require the support material and regions 1003 are regions in which the material of the object is arranged. The height of the layer of an external region 1002 is lower than the maximal height at which the support material is needed, so that the support material is arranged therein.

FIG. 11 illustrates an example of generating modeling data based on a target layer 1111 of surface shape data 1100. The target layer 1111 illustrated in FIG. 11 is above the height 820.

The target layer 1111 is formed of an internal region 1121 (including a part of the object) and external regions 1122 (including no part of the object).

The determiner 711 determines whether the external regions 1122 are included in the region 802 requiring the support material in FIG. 8. When determining that the external regions 1122 are included in the region requiring the support material, the determiner 711 determines necessity or unnecessity of the support material based on the region 803 at the maximal height as indicated by the maximal height information. In other words, when the height of a current layer is higher than the maximal height of the regions 812 corresponding to the external region 1122, the determiner 711 determines that the support material is not required therefor.

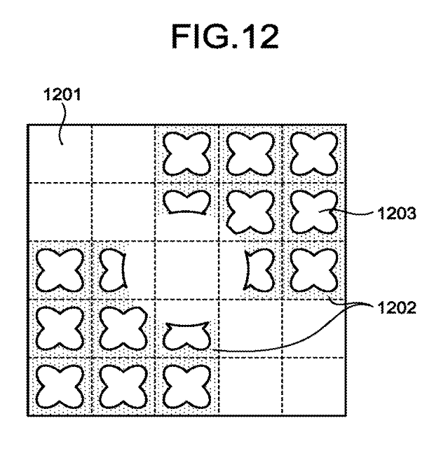

FIG. 12 illustrates a support-material requiring region in the target layer 1111 illustrated in FIG. 11. In the example illustrated in FIG. 12, a region 1201 as a combination of the circular region with the external regions does not require the support material, and regions 1203 are regions in which the material of object is arranged. The support material is arranged only in regions 1202, of the internal region, in which no material of the object is arranged.

An additive manufacturing unit 103 arranges the support material in the regions 1202 as determined to require the support material by the determiner 711 to form a layer, in accordance with data output from an output 115.

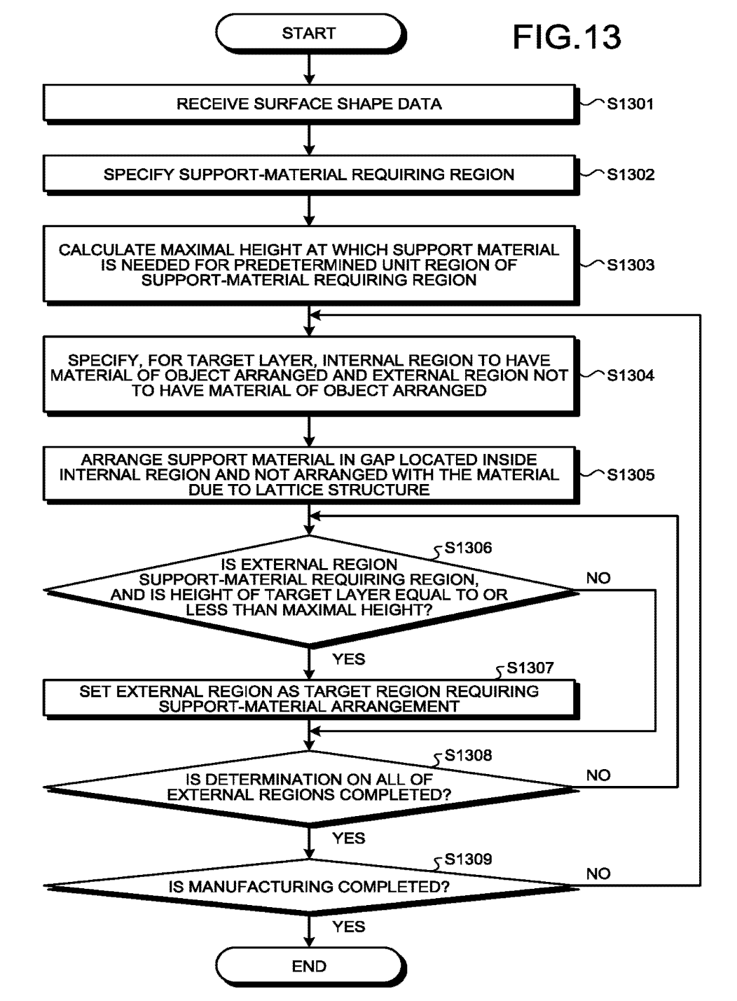

Next, determination processing by the determiner 711 of the 3D additive manufacturing apparatus 700 of the present embodiment will be described. FIG. 13 is a flowchart of the determination processing by the determiner 711 of the 3D additive manufacturing apparatus 700 of the present embodiment.

First, the determiner 711 acquires surface shape data from the surface shape data storage 112 (S1301).

Then, the determiner 711 specifies a support-material requiring region from the surface shape data (S1302).

The determiner 711 calculates maximal height at which the support material is needed, for each predetermined unit region of the support-material requiring region (S1303). The determiner 711 repeats below processing (S1304 to S1309) for each layer.

The determiner 711 specifies, for a target layer, an internal region in which a material of the object is arranged and external regions in which no material of the object is arranged (S1304).

The determiner 711 arranges the support material in a gap located inside the internal region and not arranged with the material due to lattice structures (S1305).

The determiner 711 determines whether an external region is the support-material requiring region and a height of the target layer is equal to or less than a maximal height set for this region (S1306). When determining that the external region is not included in the support-material requiring region or the height of the target layer is higher than the maximal height (No in S1306), the determiner 711 proceeds to S1308 without arranging the support material in the external region.

Meanwhile, when determining that the external region is include the support-material requiring region and the height of the target layer is equal to or less than the maximal height set for this region (Yes in S1306), the determiner 711 sets the external region as a target region requiring the support-material arrangement (S1307).

The determiner 711 determines whether the determination on all of the external regions of the target layer is completed (S1308). Upon determining non-completion of the determination on all of the external regions of the target layer (No in S1308), the determiner 711 performs the processing from S1306 again.

On the other hand, when the determiner 711 determines completion of the determination on all of the external regions of the target layer (Yes in S1308), the output 115 outputs, to the additive manufacturing unit 103, the regions requiring the arrangement of the support material as determined by the determiner 711.

Then, the determiner 711 determines whether the additive manufacturing unit 103 has completed the additive manufacturing of the object (S1309). Upon determining non-completion (No in S1309), the determiner 711 performs the processing again from S1304.

When determining that the additive manufacturing unit 103 has completed the additive manufacturing of the object (Yes in S1309), the determiner 711 ends the processing.

In the present embodiment, the additive manufacturing unit 103 is controlled not to arrange the support material in the region not requiring the support material, thereby reducing the use of the support material. This can achieve saving of the support material and cost reduction, for example.

### Third Embodiment

The above embodiments have described the examples where the lattice structure of the object does not vary in density. However, the object may have varying density. A third embodiment will describe an example where the density of the object varies.

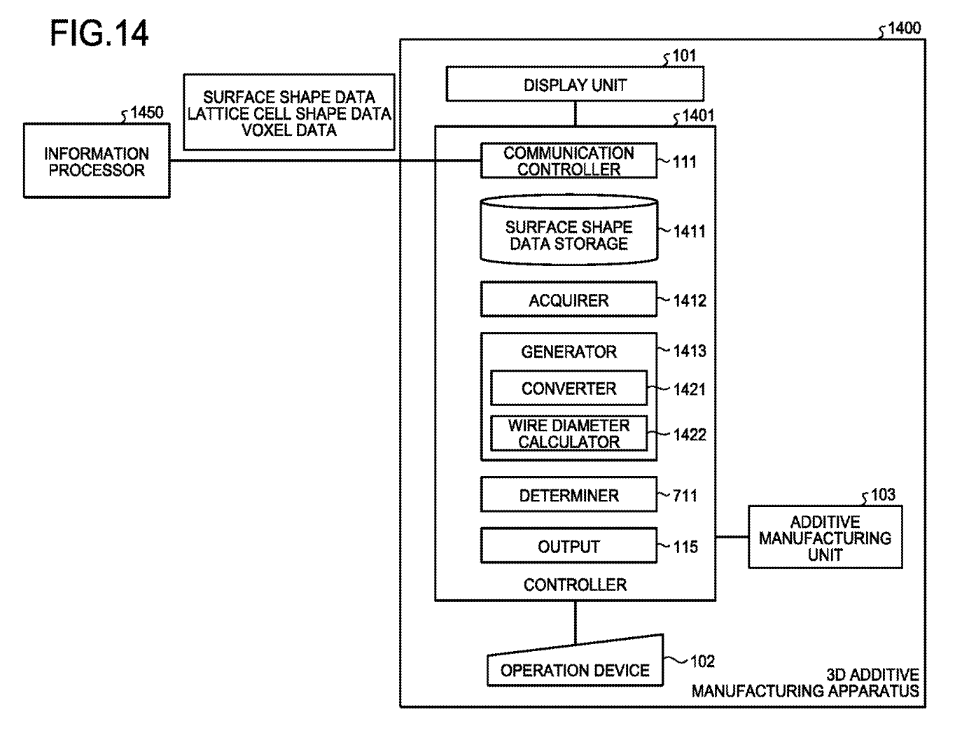

FIG. 14 exemplifies an information processor and a configuration of a 3D additive manufacturing apparatus of the third embodiment.

An information processor 1450 of the third embodiment transmits voxel data to a 3D additive manufacturing apparatus 1400 in addition to surface shape data and lattice cell shape data.

The voxel data represents a mass of cubes having a small volume and is a kind of volume data including a scalar value/a vector value corresponding to the cube (hereinafter also referred to as voxel value). In the present embodiment, various kinds of attributes can be set as the voxel value corresponding to the cube. For example, in computed tomography (CT) scanning, Hounsfield unit of an X ray may be set as the voxel value, and density or a change rate of flow speed obtained from MRI or ultrasonic waves may also be set as the voxel value. In the present embodiment, such a difference in the voxel value is expressed as a difference in density of the lattice cells of the lattice structure of the object. In the present embodiment, the volume data is not limited to the voxel data. The volume data may be arbitrarily set as long as it can have a scalar value and a vector for each unit cell in a 3D space.

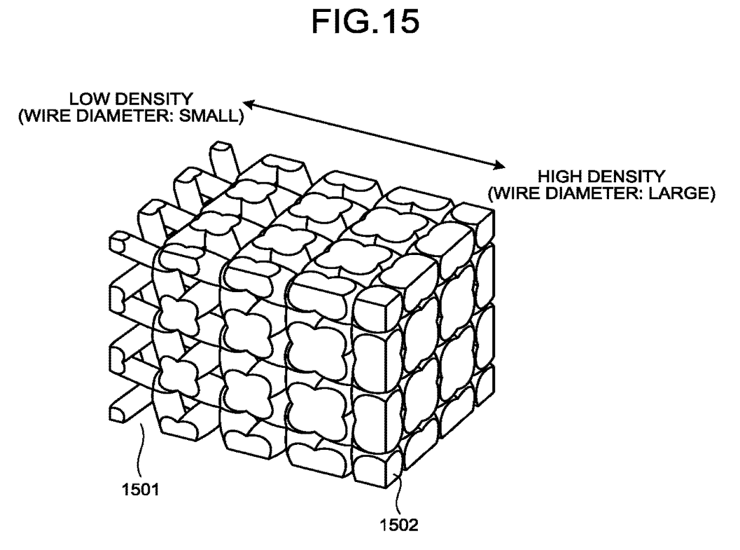

FIG. 15 exemplifies lattice cells of the object with different densities in the present embodiment. As illustrated in FIG. 15, a wire diameter of the lattice cells is changed in accordance with the density without change in the size of the lattice cells. In other words, the wire diameter is reduced at lower density as with a lattice cell 1501, and the wire diameter is increased at higher density as with a lattice cell 1502.

Referring back to FIG. 14, the 3D additive manufacturing apparatus 1400 of the third embodiment differs from the 3D additive manufacturing apparatus 700 of the second embodiment in a controller 1401 that performs different processing, for example.

The controller 1401 implements a communication controller 111, an acquirer 1412, a generator 1413, a determiner 711, and an output 115 by a CPU's executing a program stored in a ROM. A surface shape data storage 1411 is provided in a RAM. The same or like components as those in the second embodiment are denoted by the same reference signs, and a description thereof will be omitted.

The communication controller 111 receives surface shape data, lattice cell shape data, and voxel data from the information processor 1450.

The communication controller 111 stores the received surface shape data, lattice cell shape data, and voxel data in the surface shape data storage 1411.

The acquirer 1412 acquires, in addition to the surface shape data and lattice cell shape data, the voxel data including the vector value/scalar value for each region of a 3D space inside the surface shape data. In the present embodiment, the vector value/scalar value of each region is processed as a difference in density. The acquirer 1412 of the present embodiment acquires, as the volume data, voxel data stereoscopically representing CT image data captured by a CT imaging device. In the present embodiment, an imaging device is not limited to the CT imaging device, and may also be a magnetic resonance imager (MRI) or an ultrasonic image diagnostic device.

The generator 1413 includes a converter 1421 and a wire diameter calculator 1422, and changes the shape of lattice cells in accordance with the acquired voxel data (difference in density) to generate layer modeling data.

In the present embodiment, the lattice cell shape of the layer modeling data is changed in accordance with the voxel data, but the sizes of the lattice cells of the modeling data are all the same (that is, unit regions needed for the lattice cells are all the same in size).

The converter 1421 converts, for each lattice cell, the difference in the density of the unit regions in the 3D space indicated by voxel data. That is, the size of a cell indicated by the voxel data may differ from the size of a unit region in which the material is arranged based on the modeling data. The conversion by the converter 1421 of the present embodiment is thus intended for preventing such a difference in the size.

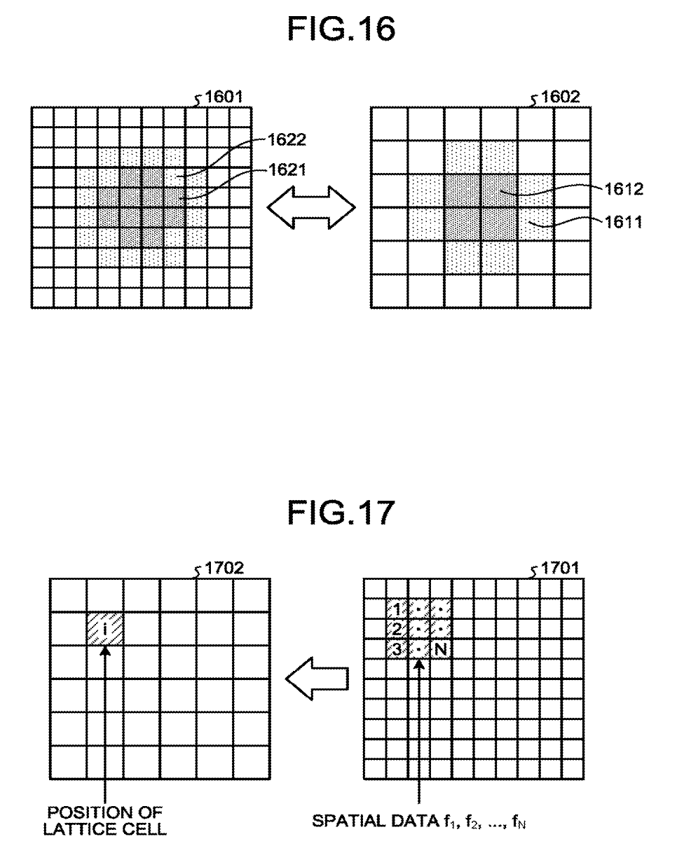

FIG. 16 exemplifies a difference in size between unit cells of the voxel data and the lattice cell shape data. FIG. 16 shows an example of conversion between a 3D space 1601 of the voxel data and a 3D space 1602 representing the lattice cell shape data. Granularity of the 3D space differs depending on an actual embodiment, and the voxel data (volume data) may have granularity larger than the 3D lattice cell shape data does.

In the example illustrated in FIG. 16, the converter 1421 converts a region 1622 of the voxel data into a space 1611 having the lattice cells arranged, and converts a region 1621 of the voxel data into a space 1612 having the lattice cells arranged.

Next, an exemplary conversion performed by the converter 1421 will be described. FIG. 17 illustrates an exemplary data conversion by the converter 1421. FIG. 17 shows the example of converting an element value (scalar value/vector value) of spatial data 1701 of the voxel data to an element value of spatial data 1702 having lattice cells arranged. In order to calculate an element value Fᵢ at a position i, the converter 1421 extracts values f₁, f₂, . . . , f_{N} indicating elements of the spatial data 1701 (in the vicinity of the position i).

Then, the converter 1421 calculates the value Fᵢ by plugging the values f₁, f₂, . . . , f_{N} indicating the elements of the spatial data 1701 into the following Formula (1), where a variable k represents a parameter that changes from one to N and wᵢₖ represents an arbitrary weight coefficient.

$${F}_{i} = \frac{{\sum }_{k} {f}_{k} {w}_{ik}}{{\sum }_{k} {w}_{ik}} \qquad ( 1 )$$

The present embodiment is not limited to the above conversion method, and other conversion methods may also be used.

For example, the converter 1421 extracts an element value xⱼ of spatial data of the voxel data at a position nearest to the lattice cell at the position i. Then, the converter 1421 calculates a gradient ∇f at the nearest position by a finite difference method from the value fⱼ of the spatial data at the nearest position and peripheral element values. The converter 1421 can calculate the value Fᵢ of the lattice cell at the position i by the following Formula (2), where the value xⱼ represents a coordinate of the element nearest to the position i in the spatial data of the voxel data, and the value xᵢ represents a coordinate of the position i in the spatial data of the lattice cell.

Fᵢ=f+∇f(xⱼ−xᵢ) (2)

Thereby, the converter 1421 can derive a change in density of each of the lattice cells arranged in the spatial data.

After the data conversion by the converter 1421, the wire diameter calculator 1422 calculates the change in density of each lattice cell (converted from the voxel data) as a wire diameter of the lattice cell in question. The wire diameter calculator 1422 calculates the wire diameter in each lattice cell of the lattice structure of the object in accordance with the change in density. This can obtain the structure as illustrated in FIG. 15. The present embodiment describes the example in which density is changed in accordance with the wire diameter. However, any method may be used as far as the change in density can be expressed by changing the shape of the lattice cells.

According to the present embodiment, the 3D additive manufacturing apparatus 1400 can create the object having varying density based on the volume data.

First Modification of Third Embodiment

The third embodiment has described the example of acquiring both the surface shape data and the voxel data. However, the voxel data includes information on the 3D shape. In view of this, a first modification of the third embodiment exemplifies manufacturing of an object based on voxel data.

Thus, the information processor 1450 transmits lattice cell shape data and voxel data to the 3D additive manufacturing apparatus 1400.

Then, the communication controller 111 of the 3D additive manufacturing apparatus 1400 stores the lattice cell shape data and the voxel data in the surface shape data storage 1411.

The acquirer 1412 acquires, from the voxel data, shape data of each layer having a predetermined thickness to be added for manufacturing the object. The subsequent processing is the same as in the third embodiment, therefore, a description thereof will be omitted.

Second Modification of Third Embodiment

The third embodiment has not considered use of mixed materials. A second modification of the third embodiment will describe the example of using mixed materials.

The acquirer 1412 in the second modification of the third embodiment acquires voxel data. At the time of forming and adding layers in a predetermined thickness for manufacturing of an object, the additive manufacturing unit 103 changes a mixing ratio of materials in accordance with a change in density indicated by the acquired voxel data. Thereby, more flexible additive manufacturing of objects can be achieved by changing not only the wire diameter of the stereoscopic lattices but also the mixing ratio of the materials.

While certain embodiments have been described, these embodiments have been presented by way of example only, and are not intended to limit the scope of the inventions. Indeed, the novel embodiments and modifications described herein may be embodied in a variety of other forms; furthermore, various omissions, substitutions and changes in the form of the embodiments and modifications described herein may be made without departing from the spirit of the inventions. The accompanying claims and their equivalents are intended to cover such forms or modifications as would fall within the scope and spirit of the inventions.

What is claimed is:

1. An additive manufacturing apparatus comprising:
an acquirer that acquires, from three-dimensional shape data, shape data of each layer in a predetermined thickness to be added for manufacturing an object;
a generator that generates layer modeling data from the shape data of each layer, the layer modeling data representing a cross-sectional shape of modeling data, the modeling data having a lattice structure converted from an inside of the object generated from the three-dimensional shape data; and
an additive manufacturing unit that forms each layer in the predetermined thickness and adds the layers for manufacturing the object, in accordance with the layer modeling data generated by the generator.

2. The additive manufacturing apparatus according to claim 1, wherein the generator divides the three-dimensional shape data into preset three-dimensional regions and generates the layer modeling data that is a part of the modeling data with lattice structures, the modeling data being generated by replacing the three-dimensional regions with a preset lattice cell shape.

3. The additive manufacturing apparatus according to claim 2, wherein
the acquirer further acquires volume information indicating a value of each of the regions in the three-dimensional shape data, and
the generator further generates the layer modeling data by changing the lattice cell shape in accordance with the value of each of the regions in the acquired volume information.

4. The additive manufacturing apparatus according to claim 1, wherein
the acquirer further acquires volume information indicating a value of each of the regions in the three-dimensional shape data, and
the additive manufacturing unit changes a mixing ratio of materials of the object in accordance with the value of each of the regions in the acquired volume information, at the time of forming each layer in the predetermined thickness and adding the layers for manufacturing the object.

5. The additive manufacturing apparatus according to claim 4, wherein the generator further includes a converter that converts the value of each of the regions indicated by the volume information into a value of each lattice cell.

6. The additive manufacturing apparatus according to any one of claim 1, wherein the additive manufacturing unit arranges a material of the object in each of the layers and arranges a support material in a region other than a region in which the material is arranged, at the time of forming each layer in the predetermined thickness and adding the layers for manufacturing the object.

7. The additive manufacturing apparatus according to claim 6, further comprising
a determiner that determines, for each of the regions in the layer, whether the region requires the support material, based on a shape of the three-dimensional shape data, and
the additive manufacturing unit arranges the support material in the region as determined to require the support material by the determiner.

8. The additive manufacturing apparatus according to any one of claim 1, wherein the generator sets an arbitrary thickness to an arbitrary face of the modeling data at the time of generating the layer modeling data.

9. The additive manufacturing apparatus according to claim 3, wherein the acquirer acquires information as volume information, the information stereoscopically representing image data captured by an imaging device, the volume information indicating a change in density of each of the regions in the three-dimensional shape data.

10. The additive manufacturing apparatus according to claim 4, wherein the acquirer acquires the shape data from the volume information for each of the layers in the predetermined thickness to be added for manufacturing the object.

11. A computer program product having a non-transitory computer readable medium including programmed instructions, wherein the instructions, when executed by a computer, cause the computer to perform:
acquiring, from three-dimensional shape data, shape data of each layer in a predetermined thickness to be added for manufacturing an object;
generating layer modeling data from the shape data of each layer, the layer modeling data representing a cross-sectional shape of modeling data, the modeling data having a lattice structure converted from an inside of the object generated from the three-dimensional shape data; and
outputting, to an additive manufacturing unit, the generated layer modeling data by the generating.
